(19) United States
(12) Patent Application Publication
(10) Pub. No.: US 2020/0205401 A1
(43) Pub. Date: Jul. 2, 2020

(54) LACTONES AS SOLVENTS IN AGROCHEMICAL FORMULATIONS

(71) Applicant: SYNGENTA PARTICIPATIONS AG, Basel (CH)

(72) Inventor: Gordon Alastair BELL, Bracknell, Berkshire (CH)

(73) Assignee: SYNGENTA PARTICIPATIONS AG, Basel (CH)

(21) Appl. No.: 16/614,319

(22) PCT Filed: May 10, 2018
(86) PCT No.: PCT/EP2018/062165

§ 371 Date: Nov. 15, 2019

(30) Foreign Application Priority Data
May 17, 2017 (GB) 1707930.2

(51) Int. Cl. A01N 25/04

(52) U.S. Cl. CPC A01N 25/04

(57) ABSTRACT

The present invention relates to the use of a water soluble lactone-derivative as a solvent in agrochemical formulations, as well as to such formulations per se in both concentrated and dilute form, and methods of making such formulations. In particular the invention relates to such formulations (and more specifically still, emulsifiable concentrates and/or emulsions or microemulsions) comprising a lactone derivative having six-carbon atoms and at least one pesticidally active agrochemical ingredient selected from the group consisting of a herbicide, safener, insecticide, fungicide, nematicide, molluscicide, and a plant growth regulator.

The present invention relates to the use of a water soluble lactone-derivative as a solvent in agrochemical formulations, as well as to such formulations per se in both concentrated and dilute form, and methods of making such formulations. In particular the invention relates to such formulations (and more specifically still, emulsifiable concentrates and/or emulsions or microemulsions) comprising a lactone derivative having six-carbon atoms and at least one agrochemical active ingredient selected from the group consisting of a herbicide, safener, insecticide, fungicide, nematicide, molluscicide, and a plant growth regulator.

Solvent based liquid formulations are common in the agrochemical industry. These are thermodynamically stable single phase formulations where the pesticide is dissolved in the solvent, such that the product can easily be poured from a container into a spray tank, where it is subsequently diluted with water.

Concentrated formulations which rely on water soluble solvents are normally called dispersion concentrates (DC). These formulations can be difficult to formulate as the dissolved pesticide is prone to crystallization on dilution. The loss of the water-soluble solvent to the aqueous phase is normally blamed for this phenomenon.

In a further formulation type, pesticides are combined with solvent and emulsifiers to form emulsifiable concentrate formulations (EC). Upon dilution with water in a spray tank the resulting emulsion disperses easily throughout the tank and provides an even concentration of the pesticide. Typically such formulations have a water insoluble oil as a key ingredient. On dilution in water the oil forms droplets (thus forming an emulsion in water), which contain the pesticide. The pesticide is prevented from crystallising as it remains in the oil. However such water insoluble oils often have poor solvent power with respect to pesticidally active agrochemical ingredients. Furthermore, their high lipophilicity may have unwanted environmental or safety effects, as they may partition into body tissue from mammals, fish, aquatic organisms or beneficial insects.

In an attempt to address these drawbacks, EC formulations frequently employ a multi-solvent system where one solvent component comprises a solvent or solvents that is/are poorly soluble in water (i.e. has a high water/octanol partition coefficient or log P octanol), and a second solvent component that comprises a solvent or solvents that is/are readily soluble in water (i.e. has a low log P octanol). An example of such a solvent system would be the combination of Solvesso 200 ND (log P octanol 3.7) and acetophenone (log P octanol 1.58). The purpose of the lipophilic solvent (high log P octanol, in this case Solvesso 200 ND) is to form water insoluble droplets on dilution. This low water solubility oil does not dissolve at the level of dilution employed in the spray tank. The solvent with a higher water solubility (low log P octanol, in this case acetophenone) acts as a better solvent for the pesticide, however it may dissolve in the water on dilution resulting in precipitation of the pesticide. Thus there is a balance to be struck in designing a formulation with the right blend of solvents.

Surprisingly it has been found that gamma caprolactone, which has a high aqueous solubility value of 11% w/w, and similar lactone derivatives are well suited to the formation of EC formulations. Solvents with this degree of aqueous solubility are generally not useful in emulsifiable concentrate formulations because they do not form oil droplets on dilution in water.

However, against the odds it is demonstrated herein that gamma caprolactone and other similar lactone derivatives can be used in such formulations as a solvent for agrochemical active ingredient without the need for an oil. While it would be expected that the use of such a lactone derivative as such a solvent would lead to crystallization on dilution, it has been found that this problem does not occur, thus allowing the user to employ a water soluble solvent in the role of an oil. A further benefit is that not only is the active ingredient prevented from crystallising but the solvent is not lipophilic and is therefore potentially less of a problem to the environment, or to aquatic organisms and the like.

Thus in a first aspect the invention provides an agrochemical composition wherein the composition is an emulsion concentrate (EC) or an emulsion in water (EW), comprising: (i) an agrochemical active ingredient; and (ii) a lactone derivative having six-carbon atoms; wherein the agrochemical active ingredient of (i) is dissolved in the lactone derivative of (ii).

In a second aspect the invention provides for the use of a lactone derivative having six-carbon atoms, as a solvent for a pesticidally active agrochemical active ingredient in an emulsifiable concentrate, emulsion in water or microemulsion.

In a third aspect the invention also provides a method of making an agrochemical composition that is an emulsifiable concentrate, emulsion in water or microemulsion, which method comprises:
(i) dissolving an agrochemical active ingredient in a lactone derivative, wherein the lactone derivative has 6 carbon atoms; and
(ii) combining the solution of (i) with water or other aqueous solvent that is immiscible with the lactone derivative employed in (i).

Lactone derivatives for use in the invention are monomeric lactones, containing a total of 6 carbon atoms. Ideally they will bear a substitution on the lactone ring. Preferably they will be miscible with water (i.e. have an aqueous solubility ≥1 g/L), and have a low log P octanol 0.6). Thus ε-caprolactone (as demonstrated herein) and poly ε-caprolactone are not considered suitable lactone derivatives for use in the invention.

More preferably still, the lactone ring will be 5-membered. Particularly preferred lactone derivatives for use in the invention include gamma caprolactone (γ-caprolactone), also known as γ-ethyl-γ-butyrolactone, or 5-ethyltetrahydrofuran-2-one, having the structure

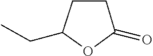

and CAS registry number 695-06-7, and 2-acetyl-gamma-butyrolactone (2-acetyl-γ-butyrolactone), also known 2-acetylbutyrolactone, 3-acetyl-dihydro-2[3H]-furanone or 3-acetyloxolane-2-one, having the structure

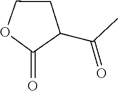

and CAS registry number 517-23-7. Most preferably the lactone derivative is γ-caprolactone.

The phrase “agrochemical active ingredient” and the noun “agrochemical” may be used interchangeably and as used herein refer to a small molecule/chemical (i.e. not a biological agent). The terms encompass herbicides, safeners, insecticides, fungicides, nematicides, molluscicides, and plant growth regulators. For the purposes of this invention, chemicals that are considered as “nutrients” or “fertilisers” for plants are not encompassed within the term. In particularly preferred embodiments the agrochemical dissolved in the lactone derivative will be selected from the group consisting of: a herbicide, a safener, an insecticide, a fungicide, and a plant growth regulator. Most preferably the agrochemical will be selected from the group consisting of: a herbicide, a safener, an insecticide, and a fungicide.

It can be seen from the Examples, that lactone derivatives as described herein, in particular γ-caprolactone, are capable of solubilising a diverse range of agrochemicals that have widely varying structures, aqueous solubilities, and modes of action. Accordingly, the lactone derivatives for use in the invention may be used to form EC formulations (or emulsions or microemulsions) with any agrochemical i.e. any herbicide, safener, insecticide, fungicide, nematicide, molluscicide or plant growth regulator.

Suitable herbicides include bicyclopyrone, mesotrione, fomesafen, tralkoxydim, napropamide, amitraz, propanil, pyrimethanil, dicloran, tecnazene, toclofos methyl, flamprop M, 2,4-D, MCPA, mecoprop, clodinafop-propargyl, cyhalofop-butyl, diclofop methyl, haloxyfop, quizalofop-P, pinoxaden, indol-3-ylacetic acid, 1-naphthylacetic acid, isoxaben, tebutam, chlorthal dimethyl, benomyl, benfuresate, dicamba, dichlobenil, benazolin, triazoxide, fluazuron, teflubenzuron, phenmedipham, acetochlor, alachlor, metolachlor, pretilachlor, thenylchlor, alloxydim, butroxydim, clethodim, cyclodim, sethoxydim, tepraloxydim, pendimethalin, dinoterb, bifenox, butafenacil, oxyfluorfen, acifluorfen, fluoroglycofen-ethyl, bromoxynil, ioxynil, imazamethabenz-methyl, imazapyr, imazaquin, imazethapyr, imazapic, imazamox, pyribenzoxim, pyriftalid, flumioxazin, flumiclorac-pentyl, picloram, amodosulfuron, chlorsulfuron, nicosulfuron, rimsulfuron, triasulfuron, triallate, pebulate, prosulfocarb, molinate, atrazine, simazine, cyanazine, ametryn, prometryn, terbuthylazine, terbutryn, sulcotrione, isoproturon, linuron, fenuron, chlorotoluron and metoxuron.

Suitable fungicides include fluxapyroxad, fluopyram, penthiopyrad, furametpyr, penflufen, bixafen, sedaxane, isopyrazam, 3-difluoromethyl-1-methyl-1H-pyrazole-4-carboxylic acid methoxy-[1-methyl-2-(2,4,6-trichlorophenyl)-ethyl]-amide, solatenol, mandipropamid, azoxystrobin, trifloxystrobin, kresoxim methyl, famoxadone, metominostrobin, picoxystrobin, cyprodanil, carbendazim, thiabendazole, dimethomorph, vinclozolin, iprodione, dithiocarbamate, imazalil, prochloraz, fluquinconazole, epoxiconazole, flutriafol, azaconazole, bitertanol, bromuconazole, cyproconazole, difenoconazole, hexaconazole, mefentrifluconazole, paclobutrazole, propiconazole, tebuconazole, triadimefon, trtiticonazole, fenpropimorph, tridemorph, fenpropidin, mancozeb, metiram, chlorothalonil, thiram, ziram, captafol, captan, folpet, fluazinam, flutolanil, fludioxonil, cyflufenamid, oxathiapiprolin, carboxin, metalaxyl, bupirimate, ethirimol, dimoxystrobin, fluoxastrobin, orysastrobin, and prothioconazole.

Suitable insecticides include thiamethoxam, imidacloprid, acetamiprid, clothianidin, dinotefuran, nitenpyram, fipronil, abamectin, emamectin, bendiocarb, carbaryl, fenoxycarb, isoprocarb, pirimicarb, propoxur, xylylcarb, asulam, chlorpropham, endosulfan, heptachlor, tebufenozide, bensultap, diethofencarb, pirimiphos methyl, aldicarb, methomyl, cypermethrin, bioallethrin, deltamethrin, lambda cyhalothrin, cyhalothrin, cyfluthrin, fenvalerate, imiprothrin, permethrin and halfenprox.

Suitable plant growth regulators include paclobutrazole, trinexapac-ethyl and 1-methylcyclopropene.

Suitable safeners include benoxacor, cloquintocet-mexyl, cyometrinil, dichlormid, fenchlorazole-ethyl, fenclorim, flurazole, fluxofenim, mefenpyr-diethyl, MG-191, naphthalic anhydride, N-(2-methoxybenzoyl)-4-[(methylaminocarbonyl)amino]benzene-sulfonamide and oxabetrinil.

Of course, the various editions of The Pesticide Manual [especially the 14^{th} and 15^{th} editions] also disclose details of agrochemicals, any one of which may suitably be used with the present invention.

In certain embodiments the agrochemical (or at least one agrochemical) that is dissolved in a lactone derivative as defined herein (in particular in γ-caprolactone) has an aqueous solubility of 10 g/litre or less at 20° C. More preferably the aqueous solubility of said agrochemical is 51 g/litre, more preferably still ≤500 mg/litre, even more preferably ≤250/mg litre, yet even more preferably ≤100 mg/litre, still more preferably 50 mg/litre and most preferably ≤20 mg litre at 20° C.

Particularly preferred agrochemicals for inclusion in compositions include one or more of those listed in Table 4 below, as well as agrochemicals similar in structure and/or mode of action to those listed in Table 4.

Emulsion concentrates, oil in water emulsions or microemulsions comprising a lactone derivative as defined herein (preferably γ-caprolactone or 2-acetylbutyrolactone, as well as at least one agrochemical listed in Table 4 below, form specific embodiments of the current invention. It should be noted that γ-caprolactone is particularly efficacious when it comes to making an EC or emulsion of azoxystrobin.

It can also be seen from the Examples that more than one (in particular two, three or four) agrochemical active ingredients may be solubilised in combination by the lactone derivatives described herein. The invention may be particularly useful for combining agrochemical active ingredients that would otherwise be difficult to solubilise in water soluble solvents or those having different aqueous solubilities, such that one (or more) agrochemical is poorly water soluble, whilst a second (or further) agrochemical is readily water soluble.

Compositions of the invention will typically comprise the agrochemical in an amount that is recommended in the art. Generally the agrochemical will be present at a concentration of about 0.001% to 90% w/v. The skilled man will appreciate that compositions of the invention may be in the form of a ready-to-use formulation (e.g. an emulsion (EW) or microemulstion), or in concentrate form (EC formulation) suitable for further dilution by the end user, and the concentration of agrochemical will be adjusted accordingly. In concentrated form, compositions of the invention typically comprise an agrochemical at 5 to 75% w/v, more preferably 10 to 50% w/v of an agrochemical. Ready-to-use compositions of the invention will typically comprise from 0.0001% to 1% w/v, more preferably from 0.001% to 0.5% w/v, and more preferably still from 0.001% to 0.1% w/v of an agrochemical.

The lactone derivative as derived herein can be used alone or in combination with other solvents, however it is surprising that the lactone derivative per se is capable of forming stable emulsions with a wide range of agrochemicals and with a wide range of emulsifiers.

Where compositions of the present invention include one or more additional solvents, these may have a range of water solubilities. Oils with very low water solubilities may be added alongside the lactone derivative for assorted reasons such as the provision of scent, safening, cost reduction, and improvement of the emulsification properties. Solvents with higher water solubility may also be added for various reasons, for instance to alter the ease with which the formulation emulsifies in water, to improve the solubility of the pesticide or of the other optional additives in the formulation, to change the viscosity of the formulation or to add a commercial benefit.

Additional formulation components may be incorporated in compositions of the invention. Such additional components include, for example, adjuvants, surfactants, emulsifiers, thickeners, and antifoams, and are well known to the man skilled in the art: standard formulation publications disclose such formulation components suitable for use with the present invention (for example, Chemistry and Technology of Agrochemical Formulations, Ed. Alan Knowles, published by Kluwer Academic Publishers, The Netherlands in 1998; and Adjuvants and Additives: 2006 Edition by Alan Knowles, Agrow Report DS256, published by Informa UK Ltd, December 2006). Further standard formulation components suitable for use with the present invention are disclosed in WO2009/130281A1 (see from page 46, line 5 to page 51, line 40).

Thus, compositions of the present invention may also comprise one or more surfactants or dispersing agents to assist the emulsification of the agrochemical on dispersion or dilution in an aqueous medium (dispersant system). The emulsification system is present primarily to assist in maintaining the emulsified agrochemical in water. Many individual emulsifiers, surfactants and mixtures thereof suitable for forming an emulsion system for an agrochemical are known to those skilled in the art and a very wide range of choices is available. Typical surfactants that may be used to form an emulsifier system include those containing ethylene oxide, propylene oxide or ethylene oxide and propylene oxide; aryl or alkylaryl sulphonates and combinations of these with either ethylene oxide or propylene oxide or both; carboxylates and combinations of these with either ethylene oxide or propylene oxide or both. Polymers and copolymers are also commonly used. Preferred surfactants are polyvinyl alcohols and ethylene glycol-propylene glycol block copolymers, and combinations thereof.

Other optional ingredients which may be added to the formulation include for example, colourants, scents, and other materials which benefit a typical agrochemical formulation.

Compositions of the invention may be used to control pests. The term “pest” as used herein includes insects, fungi, molluscs, nematodes, and unwanted plants. Thus, in order to control a pest a composition of the invention may be applied directly to the pest, or to the locus of a pest. Accordingly, in various embodiments the invention provides a method of treatment or prevention of a fungal infection in a plant, a method for the control of insects in plants, and a method for the control of unwanted plant growth. In each case the method comprises applying to said plant(s) or the locus of said plant(s), a composition comprising a fungicidal, insecticidal, or herbicidal active ingredient (as appropriate) dissolved in a lactone derivative as described herein. Compositions of the invention also have utility in the seed treatment arena, and thus may be applied as appropriate to seeds.

Various aspects and embodiments of the present invention will now be illustrated in more detail by way of example. It will be appreciated that modification of detail may be made without departing from the scope of the invention.

### EXAMPLES

### Example 1 γ-Lactone Aqueous Solubility and Log P Octanol

### 1.1 Aqueous Solubility

The aqueous solubility of gamma caprolactone was measured using HPLC chromatography. Several samples of the lactone were equilibrated at room temperature with an equal volume of water. The samples were left for two weeks then analysed by HPLC. The results of the repeat measurements are shown below in Table 1, and it can be seen quite clearly that the aqueous solubility of gamma caprolactone is approximately 11% w/w.

TABLE 1
Aqueous solubility of γ-caprolactone. Two sets of measurements
taken to establish the aqueous solubility of gamma caprolactone,
are tabulated below along with the calculated mean and % RSD.

| | Aqueous solubility (% w/w) | | |
|---|---|---|---|
| Sample | Measurement | Mean | % RSD |
| 26 | 10.915 | 11.01 | 1.34 |
| 28 | 11.018 | | |
| 30 | 11.146 | | |
| 32 | 10.938 | | |
| 34 | 11.209 | | |
| 36 | 10.821 | | |
| 38 | 10.923 | 10.93 | 1.25 |
| 40 | 10.714 | | |
| 42 | 10.954 | | |
| 44 | 11.078 | | |
| 46 | 11.059 | | |
| 48 | 10.840 | | |

### 1.2 Log P Octanol for γ-Caprolactone

Samples of gamma caprolactone were examined using an octanol saturated chromatography column. The retention time on the column indicated an octanol water partition coefficient (log P octanol) of 0.34 at a temperature of 25° C. and a pH of 6.98.

### Example 2 Solubility of the Fungicide Azoxystrobin in a Range of Organic Liquids

Azoxystrobin was dissolved in a range of organic liquids, some of which are known to be solvents for agrochemicals, at room temperature and allowed to equilibrate. A measured quantity of water was added and each mixture was shaken. The volume of water was 20 times greater than the volume of organic liquid/solvent. After settling the samples were assessed as being either (i) split into two layers with no evidence of pesticide crystalisation, or (ii) identified as a single layer where the pesticide had precipitated out as crystals.

Samples were assessed after 24 and 48 hours. The results after 48 hours are shown in Table 2. The log P octanol values for the solvents have been taken from the literature or, where this value was not available, were estimated using the program ProPred™ (ICAS ProPred™, KT Consortium, DTU Kemiteknik, Lyngby, Denmark). Where values were estimated, a simple check was carried out using measuring cylinders with 50/50 volumes of octanol and water. Solvent was added to the cylinder until a clear observation of the effect of the addition was apparent.

TABLE 2
Azoxystrobin solubility in a range of organic liquids. Organic
liquids having a range of logP octanol values were used
as solvents for the fungicide azoxystrobin. The solubility
of azoxystrobin was assessed visually at 48 hours.

| SOLVENT | logP octanol | APPEARANCE |
|---|---|---|
| Ethylene glycol | −0.78 | Crystallised |
| Dipropylene glycol | −0.76 | Crystallised |
| 2-acetyl-gamma-butyrolactone | −0.72 | 2 layers |
| γ-Butyrolactone | −0.60 | Crystallised |
| Methyl lactate | −0.47 | Crystallised |
| δ-Valerolactone | −0.26 | Crystallised |
| Dimethyl lactamide | −0.22 | Crystallised |
| γ-Valerolactone** | 0.21 | Crystallised |
| Triethyl phosphate | 0.28 | Crystallised |
| Dowanol TPM | 0.31 | Crystallised |
| γ-Caprolactone | 0.34 | 2 layer |
| Hexylene glycol | 0.44 | Crystallised |
| Dipropylene glycol monomethyl ether | 0.46 | Crystallised |
| ε-Caprolactone | 0.70 | Crystallised |
| Propylene glycol diacetate | 0.94 | Crystallised |
| Propylene glycol n-butyl ether | 1.15 | 2 layer |
| Butylene carbonate | 1.21 | 2 layer |
| Diethylene carbonate | 1.21 | 2 layer |
| Cyclohexanol | 1.23 | 2 layer |
| Propyl lactate | 1.29 | 2 layer |
| Triacetin | 1.30 | 2 layer |
| Benzyl alcohol | 1.46 | 2 layer |
| Diethyl fumarate | 1.51 | 2 layer |
| Acetophenone | 1.58 | 2 layer |
| Methyl benzoate | 1.85 | 2 layer |
| Diethylene glycol hexyl ether | 2.16 | 2 layer |
| Propyl benzoate | 3.01 | 2 layer |
| Butyl benzoate | 3.20 | 2 layer |

**gamma valerolactone initially formed two layers immediately on addition to water, but the sample crystallised over 48 hours

Surprisingly, the solutions of azoxystrobin in gamma caprolactone or 2-acetyl-gamma-butyrolactone resulted in biphasic mixtures, wherein the pesticide remained dissolved in the solvent and this solution was not water soluble.

The gamma caprolactone sample with azoxystrobin was further diluted 100-fold in water with the result that that the two layers still did not become miscible.

### Example 3 Comparison of Pesticide Solubility in Organic Liquids Having Similar Aqueous Solubility and Log P Octanol

The two solvents Dowanol™TPM (tripropylene glycol methyl ether, The Dow Chemical Company) and hexylene glycol are similar to γ-caprolactone in their log P octanol values and are also fully miscible with water at 20° C. In this example several pesticidally active agrochemical ingredients (mandipropamid, fludioxonil, pinoxaden, and difenoconazole) were dissolved in each of the three solvents to give solutions of 5% w/w. Each solution was then diluted into water to form a 20:1 mixture. The resulting observations are shown in Table 3 below.

TABLE 3
Comparative solubility of a range of agrochemical active ingredients in solvents having
similar aqueous solubility characteristics. After settling the solutions of mandipropamid,
fludixonil, pinoxaden and difenoconazole were assessed as being either (i) split into two
layers (2-layers) with no evidence of pesticide crystalisation, or (ii) identified as a
single layer where the pesticide had precipitated out as crystals (crystallised).

| Agrochemical Active Ingredient: | APPEARANCE OF FORMULATION | | | |
|---|---|---|---|---|
| SOLVENT (logP octanol) | Mandipropamid | Fludioxonil | Pinoxaden | Difenoconazole |
| Dowanol TPM (0.31) | Crystallised | Crystallised | Crystallised | Crystallised |
| γ-Caprolactone (0.34) | 2 layer | 2 layers | 2 layers | 2 layers |
| Hexylene glycol (0.44) | Crystallised | Crystallised | Crystallised | Crystallised |

Unsurprisingly, the formulations employing Dowanol™TPM and hexylene glycol as solvents, resulted in crystallisation of each of the agrochemical active ingredients. Gamma caprolactone alone was capable of retaining each of the agrochemical active ingredients in solution, and presented as a two-layer system.

### Example 4 Solubility of Agrochemicals in γ-Caprolactone

A small amount of each of the agrochemical active ingredients listed in Table 4 below, was added to, and dissolved in, gamma caprolactone as solvent. The surfactant Soprophor™ 3D33 (tristyrylphenol ethoxylate phosphate ester, SOLVAY) was then added to 5% w/w. The resulting samples were diluted in water, and all were seen to emulsify readily.

TABLE 4
Agrochemical Active Ingredients

Acetamiprid
3-difluoromethyl-1-methyl-1H-pyrazole-4-carboxylic acid
methoxy-[1-methyl-2-(2,4,6-trichlorophenyl)-ethyl]-amide
Atrazine
Butafenacil
Cloquintocet mexyl
N-(2-methoxybenzoyl)-4-[(methylaminocarbonyl)amino]ben-
zenesulfonamide
Cyflufenamid
Cyproconazole
Cyprodinil
Difenoconazole
Epoxiconazole
Fludioxynil
Isopyrazam
Mandipropamid
Napropamide
Oxyfluorfen
Pinoxaden
Prometryn
Propiconazole
Pyribenzoxim
Solatenol
Terbuthylazine
Thiamethoxam
Trinexapac ethyl

### Example 5 Preparation of an Agrochemical EC Formulation of Using γ-Caprolactone as Solvent

In this example, an EC formulation of azoxystrobin was prepared with the composition as described in Table 5 below. The ingredients were mixed together to form a clear solution. The EC was shown to be stable at room temperature for two weeks.

The emulsion characteristics were examined on dilution into water. The formulation emulsified readily in water and showed good emulsion stability over 24 hours at a dilution level of 1:100.

TABLE 5
Composition of EC containing azoxystrobin

| Component | Role | Amount (w/v) |
|---|---|---|
| Azoxystrobin | Active ingredient (fungicide) | 20 |
| Soprophor ™ BSU | Surfactant | 8 |
| γ-caprolactone | Solvent | 32 |
| Dimethyl lactamide | Solvent | 40 |

### Example 6 Formulation of a Mixture of Two Agrochemicals as an EC Using γ-Caprolactone as Solvent

In this example an EC formulation of two fungicides was prepared by combining the two fungicidal active ingredients, azoxystrobin and solatenol, with gamma caprolactone and a second solvent, dimethyl lactamide. The ingredients were mixed together to form a clear solution. A small amount of the surfactant Soprophor™ 4D384 (tristyrylphenol ethoxylate sulphate, SOLVAY) was added to the solution and the emulsion characteristics examined on dilution into water. At a dilution of 1/100 the emulsion was stable for 24 hours.

### Example 7 Formulation of Four Agrochemicals as an EC Using γ-Caprolactone as Solvent

In this example a complex EC was formed, which contained three herbicides and a herbicide safener. The components described in Table 6 below were mixed together to form an EC. The resulting EC diluted easily into water and formed a milky white emulsion.

After standing for 24 hours there was a small (negligible) amount of settling from the emulsion, which was otherwise observed to be stable.

TABLE 6
Composition of EC comprising four
agrochemical active ingredients

| Component | Role | Amount (w/v) |
|---|---|---|
| Pinoxaden (acid form) | Active ingredient (herbicide) | 6 |
| Bicyclopyrone | Active ingredient (herbicide) | 10 |
| Bromoxynil | Active ingredient (herbicide) | 20 |
| Cloquintocet-mexyl | Active ingredient (safener) | 15 |
| Triethanolamine | Surfactant | 5.7 |
| Atlas ™G-5004-LD | Surfactant | 5 |
| SERVIROX OEG 59E | Surfactant | 2 |
| Synperonic ™PE/L 64 | Surfactant | 3 |
| Dimethyl lactamide | Solvent | 18 |
| γ-caprolactone | Solvent | 15.3 |

1-15. (canceled)

16. An agrochemical composition wherein the composition is an emulsion concentrate (EC) or an emulsion in water (EW), comprising:
(i) an agrochemical active ingredient; and
(ii) gamma caprolactone or 2-acetyl-gamma-butyrolactone;
wherein the agrochemical active ingredient of (i) is dissolved gamma caprolactone or 2-acetyl-gamma-butyrolactone of (ii).

17. The agrochemical composition of claim 16, additionally comprising a surfactant.

18. The agrochemical composition according claim 16, wherein the agrochemical active ingredient is a herbicide, safener, insecticide, fungicide, nematicide, molluscicide, or plant growth regulator.

19. The agrochemical composition according to claim 16, wherein the agrochemical active ingredient is a herbicide, safener, insecticide or fungicide.

20. The agrochemical composition according to claim 16 wherein the agrochemical active ingredient has an aqueous solubility of less than 10 g/1 at 20° C.

21. Use of gamma caprolactone or 2-acetyl-gamma-butyrolactone as a solvent for a pesticidally active agrochemical active ingredient, in an emulsifiable concentrate, emulsion in water or microemulsion.

22. A method of making an agrochemical composition that is an emulsifiable concentrate, emulsion in water or microemulsion, which comprises
(i) dissolving an agrochemical active ingredient in gamma caprolactone or 2-acetyl-gamma-butyrolactone; and
(ii) combining the solution of (i) with water or other aqueous solvent that is immiscible with the gamma caprolactone or 2-acetyl-gamma-butyrolactone employed in (i).

23. A method of controlling a pest, comprising applying an agrochemical composition as defined in claim 16, to said pest or the locus of said pest.

24. A method of treatment or prevention of a fungal infection in a plant comprising applying to said plant or the locus of said plant, a composition comprising a fungicidal active ingredient dissolved in gamma caprolactone or 2-acetyl-gamma-butyrolactone.

25. A method for the control of insects in plants, comprising applying to said plant or the locus of said plant, a composition comprising an insecticidal active ingredient dissolved gamma caprolactone or 2-acetyl-gamma-butyrolactone.

26. A method for the control of unwanted plant growth, comprising applying to said plant or the locus of said plant, a composition comprising a herbicidal active ingredient dissolved in gamma caprolactone or 2-acetyl-gamma-butyrolactone.
